(19) United States
(12) Patent Application Publication
(10) Pub. No.: US 2009/0267510 A1
(43) Pub. Date: Oct. 29, 2009

(54) DISCHARGE LAMP

(75) Inventors: Wilhelmus Johannes Jacobus Welters, Turnhout (BE); Bennie Josephus De Maagt, Eindhoven (NL); Alessio Corazza, Como (IT); alberto Coda, Gerenzano (IT)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/305,006

(22) PCT Filed: Jun. 19, 2007
(86) PCT No.: PCT/IB2007/052342

§ 371 Date: Dec. 16, 2008

(30) Foreign Application Priority Data
Jun. 19, 2006 (EP) 06115624.6

(51) Int. Cl. H01J 61/26

(52) U.S. Cl. 313/562

(57) ABSTRACT

In a discharge lamp comprising a discharge vessel enclosed with space by an outer, a hydrogen getter is used comprising more than 70% by weight of Y and one or more Y alloys from Al and/or Mn. The getter effectively removes hydrogen from the outer bulb.

The invention concerns a discharge lamp, provided with a discharge vessel enclosed with space by an outer bulb and which space is provided with a getter.

Such a discharge lamp is known from WO 2002/001424. An example of such a discharge lamp is a metal halide lamp. A further example of such a discharge lamp with widespread application is a high-pressure sodium (HPS) lamp, which has a ceramic discharge vessel. The getter is present in the lamp in order to remove hydrogen that comes to be in the outer bulb during lamp manufacture and during lamp operation. If this hydrogen is not removed from the outer bulb, this hydrogen also enters the discharge vessel by diffusion somewhere through the discharge vessel wall or via the electrical feed-throughs. In this case re-ignition of the discharge lamp will be problematic. Furthermore, the presence of hydrogen (and other gases) would lead to poor heat isolation of the discharge tube, thus affecting lamp properties in a negative way. The getter comprises Co, Zr and one or more rare earth metals. In lamps having a ceramic discharge vessel, particular one made of alumina, an enhanced aluminum transport to the outer bulb and corrosion can frequently be observed after some thousands of burning hours, which adversely affects the lifetime of the lamp. Another drawback is formed by sodium loss, which is observed particular in HPS lamps. On the other hand Co is an environmentally hazardous substance. Ceramic discharge vessel is to mean in this respect a discharge vessel made of translucent crystalline metal-oxide like mono-crystalline sapphire, or densely sintered poly-crystalline alumina (aluminum oxide) or translucent crystalline aluminum nitride.

It is an object of the invention to provide a discharge lamp provided with an outer bulb and provided with a getter, in which hydrogen is removed in an effective manner from the outer bulb by the getter without the above-indicated drawbacks.

To achieve this a discharge lamp as mentioned in the opening is characterized in accordance with the invention in that the getter comprises more than 70% by weight Y and moreover one or more Y alloys of either Al or Man or of Al and Mn.

It has been found that in a discharge lamp in accordance with the invention hydrogen is very effectively removed from the space enclosed by the outer bulb of the discharge lamp In lamps with a ceramic discharge vessel there was a significant reduction in the occurrence of an enhanced alumina transport and/or sodium loss.

In a preferred embodiment of a discharge lamp in accordance with the invention, the space enclosed by the outer bulb is vacuum. It has been found that the getter that is used in the outer bulb of a discharge lamp in accordance with the invention is able to effectively getter hydrogen without becoming poisoned during the lamp sealing process.

Good results have been obtained for embodiments of a discharge lamp in accordance with the invention in which Y alloys present in the getter are chosen from the group comprising Al₂Y, Al₃Mn₇Y and AlMnY.

Good results have likewise been obtained for embodiments of a discharge lamp in accordance with the invention in which the percentage by weight of the total amount of Y in the getter is selected to be between 60% and 85%, the percentage by weight of Mn in the getter between 5% and 30% and the percentage by weight of the Al between 5% and 20%.

Discharge lamps in accordance with the invention with which good results have been obtained are amongst others metal halide lamps, more specifically those having a ceramic discharge vessel. It has been found that the quantity of hydrogen in the outer bulb of these lamps after a relatively low number of burning hours has fallen to virtually nil. In comparison with lamps provided with the known getter the resulting hydrogen equilibrium pressure is even a factor 50 smaller.

An example of the invention will be explained in more detail with reference to a drawing. In the drawing

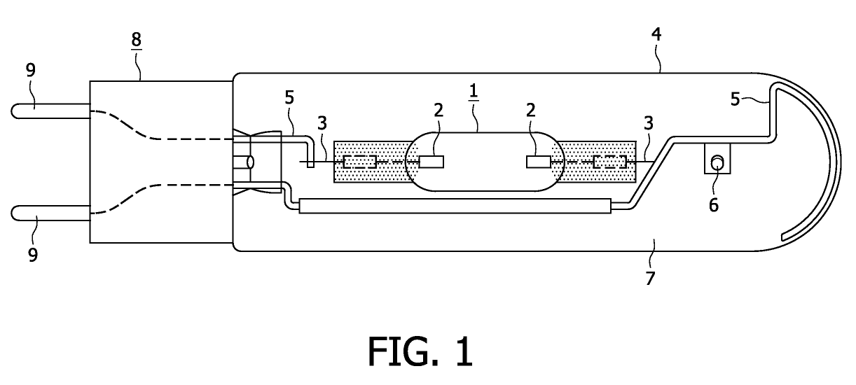

FIG. 1 shows an example of a discharge lamp in accordance with the invention having a discharge vessel made of quartz glass, and

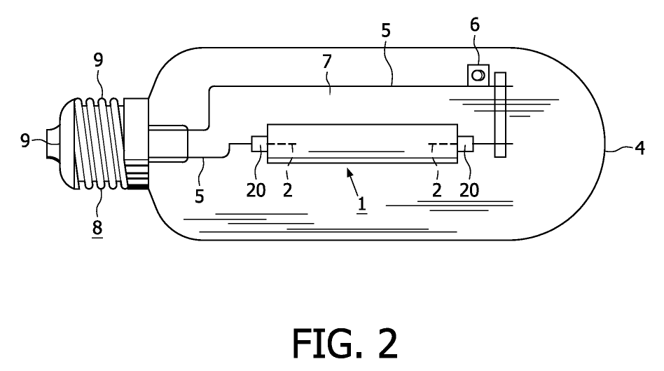

FIG. 2 shows an example of a discharge lamp according to the invention having a ceramic discharge vessel.

In FIG. 1 there are contacts 9 for securing the discharge lamp to a power supply. The contacts 9 are secured to a lamp base 8. At the lamp base 8, an outer bulb 4 formed from hard glass is secured that surrounds with space 7 a discharge vessel 1. The discharge vessel 1 is formed from quartz glass and is secured to supply conductors 5. At one of the supply conductors 5, also a getter 6 is secured. The getter 6 is manufactured by SAES, is referred to as St 789/DF50 and comprises approximately 75% by weight Y, 15% by weight Mn and 10% by weight Al. The discharge lamp is a metal halide lamp and the discharge vessel comprises 60 mbar Ar and a mixture of metal iodides. Reference numeral 2 refers to electrodes of the discharge lamp that are connected via current supply conductors 3 with the supply conductors 5. For a discharge lamp as shown in FIG. 1 it has been found that the quantity of hydrogen present in the space enclosed by the outer bulb after 100 hours of burning and after 200 hours of burning is less than 0.001 vol. %.

In the lamp displayed in FIG. 2 parts corresponding with those shown in FIG. 1 have a corresponding reference number. The discharge vessel 1 is made from ceramic, preferably alumina. Feed-through elements 20 provide electrical contacts between internal electrodes 2 and the supply conductors 5. The discharge vessel of the lamp has a filling of Hg, a noble gas like Xe and sodium. In both lamps the space 7 enclosed by the outer bulb is vacuum.

Table I shows the results of an experiment in which the effectiveness of both the St 789/DF50 getter and a known getter being the St787 getter from SAES are evaluated. The getter St787 comprises 82% by weight Zr, 12% by weight Co, 3% by weight Ce and 1% by weight each for La, Nd and Ti. For each of the getters the activity for hydrogen absorption expressed in the maximum hydrogen getter speed Jₘₐₓ has been investigated as function of temperature. The table shows the maximum hydrogen getter speed Jₘₐₓ of the two getters at the temperatures of 250, 270, 300, 400, 500, 550 and 600° C. It can be seen that the maximum hydrogen getter speed of St789/DF50 is higher than that of St787 for temperatures above 270° C. Furthermore, it can be seen that for the temperature range above 500° C. the maximum hydrogen getter speed Jₘₐₓ of the invented getter is still increasing, whilst for the getter St787 the said speed is constant. Also the getter capacity Q (mbar.ml/mg) of each of the getters has been investigated. The investigation revealed that over the temperature range from 250° C. to 550° C. the average getter capacity Q for the getter St787 is 140 (mbar.ml/mg) and for the getter St789DF50 is 120 (mbar.ml/mg). The magnitude of this difference is such that the getter St789DF50 is equally suitable for application as hydrogen getter in a discharge lamp.

TABLE I

| | |
|---|---|
| Temperature | Jₘₐₓ(mbar · ml/min · mg) |

| T (° C.) | St789 | St787 |
|---|---|---|
| 250 | 1.0 | 2.0 |
| 270 | 3.4 | 3.0 |
| 300 | 4.6 | 3.8 |
| 350 | 4.6 | 4.0 |
| 400 | 4.8 | 4.2 |
| 450 | 6.4 | 4.4 |
| 500 | 6.4 | 4.6 |
| 550 | 6.7 | 4.6 |
| 600 | 7.0 | — |

Finally, hydrogen equilibrium isotherms have been established both for the known getter St787 as well as for the invented getter St789. Results are summarized in Table II. In the table values of the equilibrium pressure are shown in mbar belonging to several values of the temperature and different values of the hydrogen concentration in cc.mbar/mg. From Table II it is seen that for the getter according to the invention the equilibrium hydrogen pressure is 50 times or more smaller than hydrogen equilibrium pressure for the known getter St787 at the same circumstances.

TABLE II

| | hydrogen concentration (cc · mbar/mg) | | | | | | | |
|---|---|---|---|---|---|---|---|---|
| Temperature | 2 | | 4 | | 8 | | 10 | |
| T (° C.) | St789 | ST787 | St789 | St787 | St789 | St787 | St789 | St787 |
| 600 | — | 1.9 * 10⁻³ | 1.3 * 10⁻⁴ | 6.5 * 10⁻³ | 4 * 10⁻⁴ | 2.8 * 10⁻² | 9 * 10⁻⁴ | 4 * 10⁻² |
| 650 | 1.2 * 10⁻⁴ | 6 * 10⁻³ | 4.8 * 10⁻⁴ | 2.3 * 10⁻² | 1.4 * 10⁻³ | 9 * 10⁻² | 1.8 * 10⁻³ | 1.5 * 10⁻¹ |
| 700 | 5.2 * 10⁻⁴ | 2 * 10⁻² | 1.8 * 10⁻³ | 7 * 10⁻² | 3.2 * 10⁻³ | 2.8 * 10⁻¹ | — | — |

1. Discharge lamp, provided with a discharge vessel enclosed, with space, by an outer bulb which space is provided with a getter, characterized in that the getter comprises more than 70 percent by weight Y and furthermore one or more Y alloys of either Al or Mn or of Al and Mn.

2. Discharge lamp as claimed in claim 1, wherein the space enclosed by the outer bulb is vacuum.

3. Discharge lamp as claimed in 1, wherein one or more of the Y alloys in the getter are chosen from the group comprising Al2Y, Al3Mn7Y and AlYMn.

4. Discharge lamp as claimed in claim 1, wherein the percentage by weight of the total amount of Y in the getter is selected to be between 60% and 85%, the percentage by weight of Mn in the getter between 5% and 30% and the percentage by weight of Al between 5% and 20%.

5. Discharge lamp as claimed in claim 1, wherein the discharge vessel has a ceramic wall.

6. Discharge lamp as claimed in claim 1, wherein the discharge lamp is a metal halide lamp.

7. Discharge lamp as claimed in claim 5, wherein the discharge lamp is a high-pressure sodium lamp.
